(19) United States
(12) Patent Application Publication
(10) Pub. No.: US 2013/0037693 A1
(43) Pub. Date: Feb. 14, 2013

(54) OPTICAL SYSTEM AND EXTREME ULTRAVIOLET (EUV) LIGHT GENERATION SYSTEM INCLUDING THE OPTICAL SYSTEM

(71) Applicants: Masato Moriya, Oyama-shi (JP); Miwa Igarashi, Oyama-shi (JP); Osamu Wakabayashi, Hiratsuka-shi (JP)

(72) Inventors: Masato Moriya, Oyama-shi (JP); Miwa Igarashi, Oyama-shi (JP); Osamu Wakabayashi, Hiratsuka-shi (JP)

(73) Assignee: GIGAPHOTON INC., Oyama-shi, Tochigi (JP)

(21) Appl. No.: 13/642,494

(22) PCT Filed: Dec. 22, 2011
(86) PCT No.: PCT/IB2011/003138

§ 371 Date: Oct. 19, 2012

(30) Foreign Application Priority Data
Feb. 2, 2011 (JP) 2011-020564
Mar. 30, 2011 (JP) 2011-075397

(51) Int. Cl. G02B 27/16; G01J 1/04; G21K 5/00

(52) U.S. Cl. 250/201.2; 250/216

(57) ABSTRACT

An optical system used with a laser apparatus may include a focusing optical system, a beam splitter, and an optical sensor. The focusing optical system has one or more focus, for focusing a laser beam outputted from the laser apparatus. The beam splitter is disposed between the focusing optical system and the one or more focus of the focusing optical system. The optical sensor is disposed on a beam path of a laser beam split by the beam splitter.

### CROSS-REFERENCE TO RELATED APPLICATIONS

The present application claims priority from Japanese Patent Application No. 2011-020564 filed Feb. 2, 2011, and Japanese Patent Application No. 2011-075397 filed Mar. 30, 2011.

### BACKGROUND

1. Technical Field

This disclosure relates to an optical system and an extreme ultraviolet (EUV) light generation system including the optical system.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes of 60 nm to 45 nm, and microfabrication with feature sizes of 32 nm or less, will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light have been known in general, which include a LPP (Laser Produced Plasma) type system in which plasma is generated by irradiating a target material with a laser beam, a DPP (Discharge Produced Plasma) type system in which plasma is generated by electric discharge, and a SR (Synchrotron Radiation) type system in which orbital radiation is used.

### SUMMARY

An optical system according to one aspect of this disclosure may be used with a laser apparatus and may include: a focusing optical system having at least one focus, for focusing a laser beam outputted from the laser apparatus; a beam splitter disposed between the focusing optical system and the at least one focus of the focusing optical system; and an optical sensor disposed on a beam path of a laser beam split by the beam splitter.

An optical system according to another aspect of this disclosure may be used with first and second laser apparatuses and may include: a beam path adjusting unit for making a beam path of a first laser beam outputted from the first laser apparatus and a beam path of a second laser beam outputted from the second laser apparatus coincide with each other; a focusing optical system having at least one focus, for focusing the first laser beam outputted from the first laser apparatus and the second laser beam outputted from the second laser apparatus; an optical sensor for detecting a focus position of the second laser beam; a focus position adjusting unit disposed on a beam path of the first and second laser beams upstream from the focusing optical system, for adjusting at least one of a beam axis and divergence of the first and second laser beams; and a focus control unit for controlling the focus position adjusting unit based on a detection result by the optical sensor.

An extreme ultraviolet light generation system according to yet another aspect of this disclosure may be used with a laser apparatus and may include: a chamber provided with at least one inlet through which a laser beam outputted from the laser apparatus is introduced into the chamber; a target supply unit for supplying a target material to a predetermined region inside the chamber; a focusing optical system for focusing at least part of the laser beam in the predetermined region; a beam splitter disposed between the focusing optical system and the predetermined region; an optical sensor disposed on beam path of a laser beam split by the beam splitter; and a collector mirror for collecting extreme ultraviolet light emitted as the target material is irradiated by the laser beam inside the chamber.

An extreme ultraviolet light generation system according to still another aspect of this disclosure may be used with first and second laser apparatuses and may include: a beam path adjusting unit for making a beam path of a first laser beam outputted from the first laser apparatus and a beam path of a second laser beam outputted from the second laser apparatus coincide with each other; a chamber provided with at least one inlet through which the first laser beam outputted from the first laser apparatus and the second laser beam outputted from the second laser apparatus are introduced into the chamber; a target supply unit for supplying a target material to a predetermined region inside the chamber; a focusing optical system for focusing the first and second laser beams in the predetermined region; an optical sensor for detecting a focus position of the second laser beam; a focus position adjusting unit, disposed on the beam path of the first and second laser beams upstream from the focusing optical system, for adjusting at least one of a beam axis and divergence of the first and second laser beams; a focus control unit for controlling the focus position adjusting unit based on a detection result by the optical sensor; and a collector mirror for collecting extreme ultraviolet light emitted as the target material is irradiated by the laser beam inside the chamber.

### BRIEF DESCRIPTION OF THE DRAWINGS

Hereinafter, selected embodiments of this disclosure will be described with reference to the accompanying drawings.

FIG. 1 schematically illustrates the configuration of an exemplary LPP type EUV light generation system.

FIG. 2 is a timing diagram for describing burst operation.

FIG. 3 schematically illustrates the configuration of an EUV light generation system according to a first embodiment of this disclosure.

FIG. 4 schematically illustrates the configuration of a beam expanding and focusing optical system including a focusing optical system according to the first embodiment.

FIG. 5 schematically illustrates the configuration of an EUV light generation system according to a second embodiment of this disclosure.

FIG. 6 schematically illustrates the configuration of an EUV light generation system according to a third embodiment of this disclosure.

FIG. 7 schematically illustrates the configuration of an EUV light generation system according to a fourth embodiment of this disclosure.

FIG. 8 schematically illustrates the configuration of a laser beam focusing optical system including a diamond beam splitter.

FIG. 9 schematically illustrates the configuration of a laser beam focusing optical system, in which a mirror having a through-hole according to another modification of a beam splitter is used.

FIG. 10 illustrates a shape of the mirror used as a beam splitter in FIG. 9.

FIG. 11 schematically illustrates the configuration of a laser beam focusing optical system, in which a diffraction grating according to yet another modification of a beam splitter is used.

FIG. 12 schematically illustrates the configuration of an EUV light generation system according to a fifth embodiment of this disclosure.

FIG. 13 illustrates an example of a guide laser beam mirror shown in FIG. 12.

FIG. 14 schematically illustrates the configuration of an EUV light generation system according to a sixth embodiment of this disclosure.

FIG. 15 is a perspective view illustrating the detailed configuration of a mount with a tilt mechanism.

FIG. 16 illustrates a detailed configuration of a focus position adjusting unit.

FIG. 17 illustrates a focus position adjusting unit according to a modification.

FIG. 18 illustrates the focus position adjusting unit according to the modification.

FIG. 19 illustrates the focus position adjusting unit according to the modification.

### DESCRIPTION OF PREFERRED EMBODIMENTS

Hereinafter, selected embodiments of this disclosure will be described in detail with reference to the accompanying drawings. The embodiments to be described below are merely illustrative in nature and do not limit the scope of this disclosure. Further, the configuration(s) and operation(s) described in each embodiment are not all essential in implementing this disclosure. Note that like elements are referenced by like reference numerals and characters, and that duplicate descriptions thereof will be omitted herein.

### Contents

### 1. Summary

### 2. Terms

### 3. Overview of EUV Light Generation System

3.1 Configuration

3.2 Operation

3.3 Burst Operation

### 4. EUV Light Generation System of First Embodiment

4.1 Configuration

4.2 Operation

4.3 Effect

4.4 Modification

### 5. EUV Light Generation System of Second Embodiment

5.1 Configuration

5.2 Operation

5.3 Effect

### 6. EUV Light Generation System of Third Embodiment

6.1 Configuration

6.2 Operation

6.3 Effect

### 7. EUV Light Generation System of Fourth Embodiment

7.1 Configuration

7.2 Operation

7.3 Effect

### 8. Beam Splitters

8.1 Diamond Beam Splitter

8.2 Mirror Having Through-Hole

8.3 Diffraction Grating

### 9. EUV Light Generation System of Fifth Embodiment

9.1 Configuration

9.2 Operation

9.3 Effect

### 10. EUV Light Generation System of Sixth Embodiment

10.1 Configuration

10.2 Operation

10.3 Effect

### 11. Supplementary Description

11.1 Mount with Tilt Mechanism

11.2 Focus Position Adjusting Unit

11.3 Modification of Focus Position Adjusting Unit

### 1. Summary

An overview of the embodiments will be given below. When a laser apparatus is operating in burst operation mode, a heat load on an optical system for focusing a pulsed laser beam may fluctuate. In such a case, the position or location at which the pulsed laser beam is focused by the optical system may also fluctuate. When the position or location at which the pulsed laser beam is focused fluctuates, the conversion efficiency into the EUV light may decline. As a result, the EUV light may not be supplied to the exposure apparatus stably or with constant power or intensity.

Further, since the pulsed laser beam is not outputted during a rest period of the burst operation mode, the position at which the pulsed laser beam is focused cannot be obtained. The shift in the focus position may be caused by vibration added to the focusing optical system. However, since this change in the focus position cannot be detected during the rest period of the burst operation mode, if the focus position changes during the rest period, the EUV light will be generated under the changed focus position condition after the burst operation mode is re-started. Accordingly, the conversion efficiency into the EUV light may decline, and in turn the EUV light may not be supplied to the exposure apparatus stably or with constant power or intensity.

### 2. Terms

Terms used in this application may be interpreted as follows. The term “droplet” may refer to one or more liquid droplet(s) of a molten target material. Accordingly, the shape of a droplet may be substantially spherical due to its surface tension. The term “plasma generation region” may refer to a three-dimensional space in which plasma is to be generated. The term “burst operation” may refer to an operation mode or state in which a pulsed laser beam or pulsed EUV light is outputted at a predetermined repetition rate during a predetermined period and the pulsed laser beam or the pulsed EUV light is not outputted outside of the predetermined period. The “predetermined repetition rate” does not have to be a constant repetition rate but may, in some examples, be a substantially constant repetition rate. In a beam path of a laser beam, a direction or side closer to the laser apparatus is referred to as “upstream,” and a direction or side closer to the plasma generation region is referred to as “downstream.” The “focus condition” may include the position or location at which the laser beam is focused, the divergence of the laser beam, and the position and direction of the beam axis of the laser beam.

### 3. Overview of EUV Light Generation System

### 3.1 Configuration

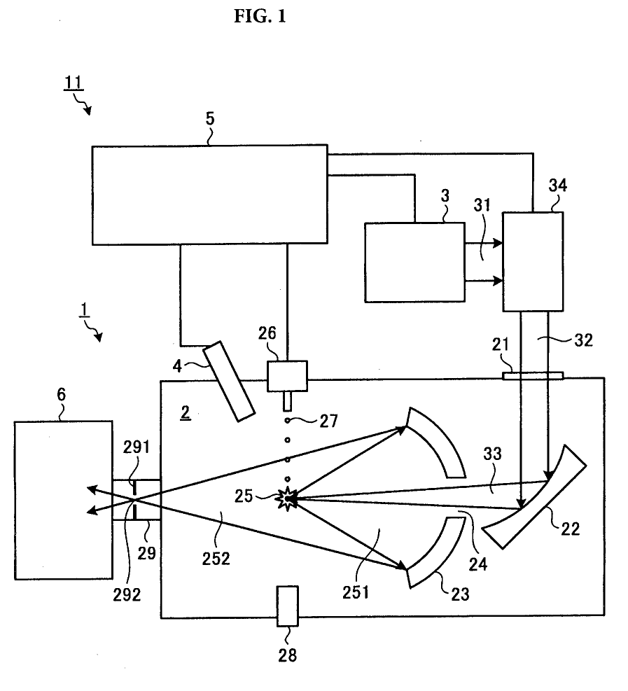

FIG. 1 schematically illustrates the configuration of an exemplary LPP type EUV light generation system. An EUV light generation apparatus 1 may be used with at least one laser apparatus 3. In this application, a system including the EUV light generation apparatus 1 and the laser apparatus 3 may be referred to as an EUV light generation system 11. As illustrated in FIG. 1 and described in detail below, the EUV light generation apparatus 1 may include a chamber 2, a target supply unit (droplet generator 26, for example), and so forth. The chamber 2 may be airtightly sealed. The target supply unit may be mounted to the chamber 2 so as to pass through the wall of the chamber 2, for example. A target material to be supplied by the target supply unit may include, but is not limited to, tin, terbium, gadolinium, lithium, xenon, or any combination, alloy, or mixture thereof.

The chamber 2 may have at least one through-hole formed in the wall thereof. The through-hole may be covered with a window 21, and a pulsed laser beam 32 may travel through the window 21 into the chamber 2. An EUV collector mirror 23 having a spheroidal reflective surface may be disposed inside the chamber 2, for example. The EUV collector mirror 23 may have first and second foci. The EUV collector mirror 23 may have a multi-layered reflective film formed on a surface thereof, and the reflective film can include molybdenum and silicon that is laminated in alternate layers, for example. The EUV collector mirror 23 may preferably be disposed such that the first focus thereof lies in a plasma generation region 25 and the second focus thereof lies in an intermediate focus (IF) region 292 defined by the specification of an exposure apparatus. The EUV collector mirror 23 may have a through-hole 24 formed at the center thereof, and a pulsed laser beam 33 may travel through the through-hole 24.

Referring again to FIG. 1, the EUV light generation system 11 may include an EUV light generation control unit 5. Further, the EUV light generation apparatus 1 may include a target sensor 4. The target sensor 4 may be equipped with an imaging function and may detect at least one of the presence, trajectory, and position of a target.

Further, the EUV light generation apparatus 1 may include a connection part 29 for allowing the interior of the chamber 2 and the interior of the exposure apparatus 6 to be in communication with each other. A wall 291 having an aperture may be disposed inside the connection part 29. The wall 291 may be disposed such that the second focus of the EUV collector mirror 23 lies in the aperture formed in the wall 291.

Further, the EUV light generation system 1 may include a laser beam direction control unit 34, a laser beam focusing mirror 22, and a target collection unit 28 for collecting a target 27. The laser beam direction control unit 34 may include an optical element for defining the direction in which the laser beam travels and an actuator for adjusting the position and the orientation (or posture) of the optical element.

### 3.2 Operation

With reference to FIG. 1, a pulsed laser beam 31 outputted from the laser apparatus 3 may pass through the laser beam direction control unit 34, and may be outputted from the laser beam direction control unit 34 as a pulsed laser beam 32 after having its direction optionally adjusted. The pulsed laser beam 32 may travel through the window 21 and enter the chamber 2. The pulsed laser beam 32 may travel inside the chamber 2 along at least one beam path from the laser apparatus 3, be reflected by the laser beam focusing mirror 22, and strike at least one target 27, as a pulsed laser beam 33.

The droplet generator 26 may output the targets 27 toward the plasma generation region 25 inside the chamber 2. The target 27 may be irradiated by at least one pulse of the pulsed laser beam 33. The target 27, which has been irradiated by the pulsed laser beam 33, may be turned into plasma, and rays of light including EUV light 251 may be emitted from the plasma. The EUV light 251 may be reflected selectively by the EUV collector mirror 23. EUV light 252 reflected by the EUV collector mirror 23 may travel through the intermediate focus region 292 and be outputted to the exposure apparatus 6. The target 27 may be irradiated by multiple pulses included in the pulsed laser beam 33.

The EUV light generation control unit 5 may integrally control the EUV light generation system 11. The EUV light generation control unit 5 may process image data of the droplet 27 captured by the target sensor 4. Further, the EUV light generation control unit 5 may control at least one of the timing at which the target 27 is outputted and the direction into which the target 27 is outputted (e.g., the timing with which and/or direction in which the target is outputted from droplet generator 26), for example. Furthermore, the EUV light generation control unit 5 may control at least one of the timing with which the laser apparatus 3 oscillates (e.g., by controlling laser apparatus 3), the direction in which the pulsed laser beam 31 travels (e.g., by controlling laser beam direction control unit 34), and the position at which the pulsed laser beam 33 is focused (e.g., by controlling laser apparatus 3, laser beam direction control unit 34, or the like), for example. The various controls mentioned above are merely examples, and other controls may be added as necessary.

### 3.3 Burst Operation

The EUV light generation system 11 may supply, to the exposure apparatus 6, pulsed EUV light 252 at a predetermined repetition rate, when wafers are exposed in the exposure apparatus 6. While a wafer is being moved or replaced, or while a mask is being replaced, exposure of a wafer may be paused or suspended. Accordingly, during the above stated periods of pause or suspension, the EUV light generation system 11 may not supply the pulsed EUV light 252 to the exposure apparatus 6.

In the EUV light generation system 11, the laser apparatus 3 may need to be controlled in order to cause the EUV light generation system 11 to supply, or to stop supplying, the pulsed EUV light 252.

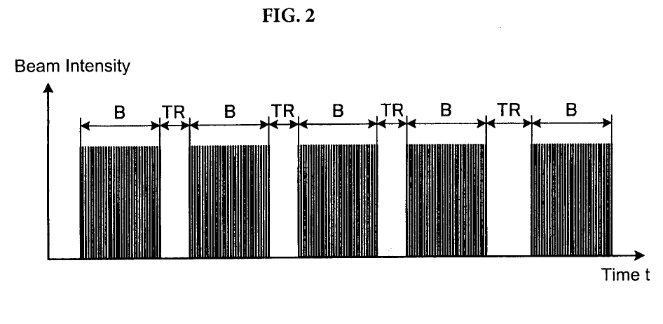

The burst operation mode may be one of several different modes or states of operation of the laser apparatus 3. In the burst operation mode, a pulsed laser beam may be outputted at a predetermined repetition rate during a first predetermined period, and the pulsed laser beam may not be outputted during a second predetermined period. The first and second periods may be non-overlapping periods, and may be repeated in alternation. For example, as shown in FIG. 2, a pulsed laser beam of uniform beam intensity may be outputted at a predetermined repetition rate during a burst period B, and the pulsed laser beam may not be outputted during a rest period TR. The pulsed laser beam may also be outputted during a series of burst periods B (e.g., burst periods that are repeated periodically), and the pulsed laser beam may not be outputted during rest periods TR (e.g., rest periods that are repeated periodically).

When the laser apparatus 3 is made to oscillate in burst operation mode, a heat load on the focusing optical system (such as the laser focusing mirror 22) may undergo larger fluctuations than when the laser apparatus 3 is made to oscillate continually. As a result of the fluctuations in heat load, the position at which the pulsed laser beam 33 reflected by the laser focusing mirror 22 is focused may fluctuate.

Further, the position at which the pulsed laser beam 33 reflected by the laser focusing mirror 22 is focused may shift due to vibrations of the laser focusing mirror 22. The fluctuation in the focus position may be detected by measuring the position at which the pulsed laser beam 33 is focused. However, with this method, it may be difficult (if not impossible) to detect the fluctuation in the focus position during the rest period TR, for example during the rest periods TR present when the laser apparatus 3 is made to operate in the burst operation mode. Accordingly, when the focus position changes during a rest period TR during which the focus position was not detected or measured, the lead pulse of a given burst period B immediately following the rest period TR may be focused in an unknown or unintended position.

### 4. EUV Light Generation System of First Embodiment

A first embodiment of this disclosure will be described in detail with reference to the drawings.

### 4.1 Configuration

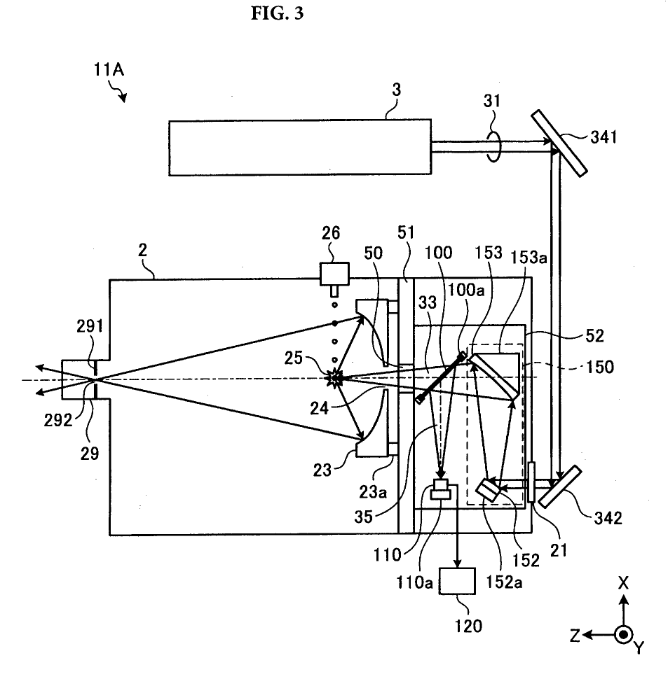

FIG. 3 schematically illustrates the configuration of an EUV light generation system 11A according to the first embodiment. As illustrated in FIG. 3, the EUV light generation system 11A may include a focusing optical system for focusing a pulsed laser beam and a beam splitter. Inside the chamber 2, which constitutes part of the EUV light generation system 11A, the EUV collector mirror 23, a beam splitter 100, an optical sensor 110, a first mirror 152, a second mirror 153, and plates 51 and 52 may be disposed. The EUV collector mirror 23 may be attached to the plate 51 via a holder 23a. The first and second mirrors 152 and 153 may be attached to the plate 52 via holders 152a and 153a, respectively. The beam splitter 100 may be attached to the plate 52 via a holder 100a so as to be positioned between the second mirror 153 and the first focus of the EUV collector mirror 23, and such that the pulsed laser beam 33 reflected by the second mirror 153 may be incident on the beam splitter 100. The beam splitter 100 may be configured so as to split a pulsed laser beam 35 from the pulsed laser beam 33 incident on the beam splitter 100. The optical sensor 110 may be attached to the plate 52 via a holder 110a such that the pulsed laser beam 35 split by the beam splitter 100 may be focused on the photosensitive surface of the optical sensor 110. The beam splitter 100 may preferably be disposed such that the distance between a given point on the beam splitter 100 and the first focus of the EUV collector mirror 23 is substantially equal to the distance between the given point and the photosensitive surface of the optical sensor 110. The optical sensor 110 may include one or more of an area sensor, a position sensitive detector (PSD), or the like. The plate 52 may be attached to the plate 51. The plate 51 may have a through-hole 50 formed therein for allowing the pulsed laser beam 33 to pass therethrough. High-reflection mirrors 341 and 342 serving as the laser beam direction control unit 34 may be interposed between the laser apparatus 3 and the chamber 2. A monitor 120 may be connected to the optical sensor 110, and the monitor 120 may display the output from the optical sensor 110 as image data or as numerical data.

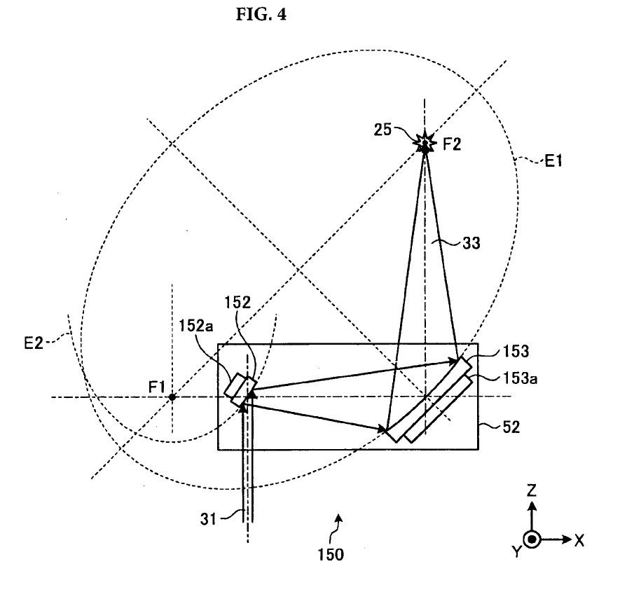

The first mirror 152 may include an off-axis paraboloidal convex mirror, and may serve as a beam expanding optical system for the pulsed laser beam. The second mirror 153 may be a spheroidal concave mirror, and may serve as a focusing optical system for the pulsed laser beam. The first and second mirrors 152 and 153 may jointly be referred to as a beam expanding and focusing optical system 150 for the pulsed laser beam. With reference to FIG. 4, the first and second mirrors 152 and 153 may be disposed such that the focus of a parabola E2 following along the extension of the reflective surface of the first mirror 152 and one of the foci of an ellipse E1 following along the extension of the reflective surface of the second mirror 153 both lie on a focus F1. Further, the second mirror 153 may be disposed such that the other focus F2 of the ellipse E1 lies in the plasma generation region 25. Here, FIG. 4 schematically illustrates the configuration of the beam expanding and focusing optical system which includes a focusing optical system.

### 4.2 Operation

The pulsed laser beam 31 outputted from the laser apparatus 3 may be reflected by the high-reflection mirrors 341 and 342 without being expanded in diameter, and enter the chamber 2 via the window 21. The pulsed laser beam 31 may be incident on the first mirror 152 at a predetermined angle (at an angle of 45 degrees with respect to the principle axis of the first mirror 152, for example) and be reflected by the first mirror 152, to thereby be expanded in diameter. The pulsed laser beam, which has been expanded in diameter, may be incident on the second mirror 153 at a predetermined angle (at an angle of 45 degrees with respect to the principle axis of the second mirror 153, for example) and be reflected by the second mirror 153, to thereby be focused at a location which coincides with the first focus of the EUV collector mirror 23. Here, the first and second mirrors may be disposed such that the pulsed laser beam incident on the first mirror 152 is reflected so as to be incident on the second mirror 153. Part of the pulsed laser beam 33 reflected by the second mirror 153 may be split by the beam splitter 100, as the pulsed laser beam 35, and the pulsed laser beam 35 may be focused on the photosensitive surface of the optical sensor 110. The optical sensor 110 may detect the focus condition of the pulsed laser beam 35 and output the focus condition information to the monitor 120. Then, the position and/or orientation of each of the high-reflection mirrors 341 and 342 may be adjusted based on the display on the monitor 120, and the focus condition of the pulsed laser beam 35 may be adjusted to a desired condition.

### 4.3 Effect

The optical sensor 110 may detect the pulsed laser beam 35, which is split from the pulsed laser beam 33. By monitoring in real-time the position at which the pulsed laser beam 35 is focused and the beam profile (focus condition) of the pulse laser beam 35, the optical sensor 110 may be able to estimate or indirectly monitor, in real-time, the position at which the pulsed laser beam 33 is focused and the beam profile (focus condition) of the focused pulsed laser beam 33.

### 4.4 Modification

The plate 51 may be configured so as to divide the interior of the chamber 2 into two spaces, one to the side of the EUV collector mirror 23 and the other to the side of the second mirror 153. In this case, the through-hole 50 may preferably be covered by a window, through which the pulsed laser beam 33 may be transmitted. When the interior of the chamber 2 is divided by the plate 51, optical systems on one side of the plate 51, such as the second mirror 153, may be prevented from being contaminated by debris emitted when the target material is turned into plasma on the other side of the plate 51.

### 5. EUV Light Generation System of Second Embodiment

A second embodiment of this disclosure will be described in detail with reference to the drawings.

### 5.1 Configuration

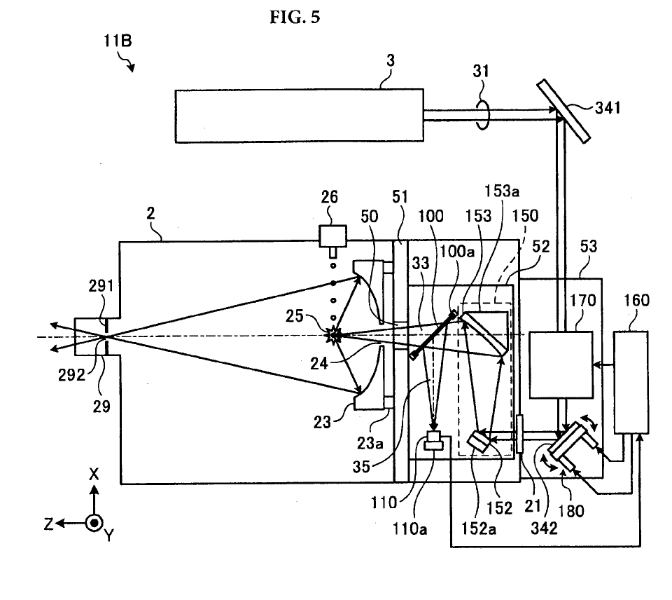

FIG. 5 schematically illustrates the configuration of an EUV light generation system 11B according to the second embodiment. As illustrated in FIG. 5, the EUV light generation system 11B may include a focusing optical system for the pulsed laser beam, a beam splitter, and a system for using feedback-control to adjust the focus position of the pulsed laser beam. Here, the EUV light generation system 11B may be similar in configuration to the EUV light generation system 11A shown in FIG. 3 and may further include a focus control unit 160, a focus position adjusting unit 170, a mount 180 equipped with a tilt mechanism, and a plate 53. The focus position adjusting unit 170 may be disposed on the beam path between the high-reflection mirrors 341 and 342. The high-reflection mirror 342 may be held by the mount 180. The focus position adjusting unit 170 and the mount 180 may be attached to the plate 53. The focus control unit 160 may be connected to and receive input from the optical sensor 110. The focus control unit 160 may be connected to and transmit control commands to the focus position adjusting unit 170 and the mount 180.

### 5.2 Operation

The pulsed laser beam 35 may be focused on the photosensitive surface of the optical sensor 110. The focus condition information of the pulsed laser beam 35 detected by the optical sensor 110 may be inputted to the focus control unit 160. Based on the inputted focus condition information, the focus control unit 160 may calculate or estimate the focus position and the beam profile of the pulsed laser beam 35. Then, based on the calculated or estimated focus position and beam profile, the focus control unit 160 may use feedback-control to adjust the focus position using the adjusting unit 170 and the mount 180 so that the pulsed laser beam 35 can be focused in a desired condition. The focus position adjusting unit 170 may adjust the wavefront of the pulsed laser beam 31 incident thereon, to thereby adjust the focus position of the pulsed laser beam 33 in the direction of the beam axis and the beam profile. The focus position adjusting unit 170 may further be used to adjust at least one of a beam axis (including a position of a beam axis and/or a direction of the beam axis) and divergence of the laser beam. The mount 180 may function as a beam axis adjusting unit. In that case, the mount 180 may adjust the direction of the beam axis of the pulsed laser beam 31, to thereby adjust the focus position of the pulsed laser beam 33. The direction of the beam axis of the pulsed laser beam 31 may be adjusted by causing the mount 180 to change an orientation of the high-reflection mirror 342, for example.

### 5.3 Effect

The focus condition of the pulsed laser beam 35 detected by the optical sensor 110 may reflect the focus condition of the pulsed laser beam 33. Accordingly, the focus control unit 160 may, by using feedback-control to adjust the focus condition of the pulsed laser beam 35, be able to adjust the focus condition of the pulsed laser beam 33 in real-time. For example, the focus control unit 160 may use feedback-control to adjust the focus position of the pulsed laser beam 33 to a desired focus position. Further, the focus control unit 160 may control the focus position of the pulsed laser beam 33 so as to move the focus position to a desired focus position.

### 6. EUV Light Generation System of Third Embodiment

A third embodiment of this disclosure will be described in detail with reference to the drawings.

### 6.1 Configuration

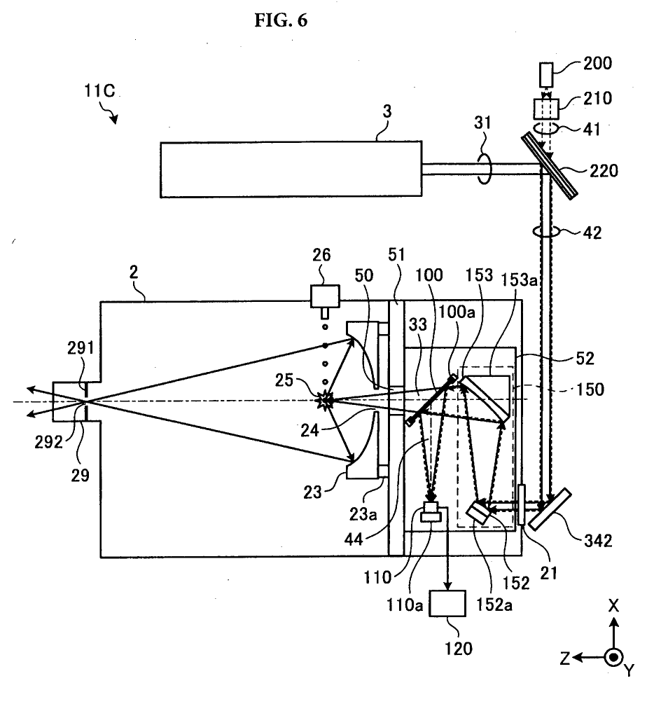

FIG. 6 schematically illustrates the configuration of an EUV light generation system 11C according to the third embodiment. As illustrated in FIG. 6, the EUV light generation system 11C may include a guide laser, a focusing optical system for a pulsed laser beam, and a beam splitter. Here, the EUV light generation system 11C may include a beam path adjusting unit 220 in place of the high-reflection mirror 341 in the EUV light generation system 11A shown in FIG. 3. Further, the EUV light generation system 11C may include a guide laser 200 and a beam expander 210. The guide laser 200 may be configured to output a continuous-wave guide laser beam even during the rest period TR of the burst operation. The beam expander 210 may be configured to expand the guide laser beam incident thereon in diameter, collimate the guide laser beam, and output the collimated guide laser beam as a guide laser beam 41. The optical sensor 110 may be configured to detect the guide laser beam 41 incident thereon. The beam path adjusting unit 220 may include a beam combiner that reflects the pulsed laser beam 31 with high reflectivity on a surface thereof and transmits the guide laser beam 41 through the adjusting unit. The beam path adjusting unit 220 may be coated with an optical thin film, which reflects the pulsed laser beam 31 with high reflectivity and transmits the guide laser beam 41 with high transmissivity, on a surface on which the pulsed laser beam 31 is incident. Further, the beam path adjusting unit 220 may be coated with an optical thin film, which transmits the guide laser beam 41 with high transmissivity, on a surface on which the guide laser beam 41 is incident. The high-reflection mirror 342, and the first and second mirrors 152 and 153 may respectively be coated with optical thin films on the respective reflective surfaces thereof, for reflecting the pulsed laser beam and the guide laser beam with high reflectivity. The beam splitter 100 may be formed of a diamond substrate. The beam splitter 100 may be coated with an optical thin film, on a surface facing the second mirror 153, for reflecting the guide laser beam with high reflectivity and transmitting the pulsed laser beam with high transmissivity. Further, the beam splitter 100 may be coated with an optical thin film, on a surface oriented toward the EUV collector mirror 23, for transmitting the pulsed laser beam and the guide laser beam with high transmissivity. The window 21 may be formed of a diamond substrate and may be coated with an optical thin film, on both principal surfaces thereof, for transmitting the pulsed laser beam and the guide laser beam with high transmissivity.

### 6.2 Operation

The beam path of the pulsed laser beam 31 and the beam path of the guide laser beam 41 may be made to substantially coincide with each other by the beam path adjusting unit 220. A laser beam 42 outputted from the beam path adjusting unit 220 may include the pulsed laser beam 31 and the guide laser beam 41. The laser beam 42 may be reflected by the high-reflection mirror 342, transmitted through the window 21, and may enter the chamber 2. The laser beam 42 may be incident on the first mirror 152 at 45 degrees and be reflected thereby. By being reflected on the paraboloidal convex surface of the first mirror 152, the laser beam 42 may be expanded in diameter. The laser beam 42 reflected by the first mirror 152 may be incident on the second mirror 153 at 45 degrees. The laser beam 42 reflected by the second mirror 153 may be focused in the first focus of the EUV collector mirror 23. The beam splitter 100 may reflect the guide laser beam 41 of the laser, beam 42 with high reflectivity, and transmit the pulsed laser beam 31 of the laser beam 42. The laser beam 42 may thus be split into a guide laser beam 44, corresponding to the reflected part of laser beam 42, and the pulsed laser beam 33, corresponding to the transmitted part of the laser beam 42. The guide laser beam 44 may be focused on the photosensitive surface of the optical sensor 110. The optical sensor 110 may detect and/or measure properties of the focused guide laser beam 44 and output the detection and measuring result to the monitor 120. In one example, the wavelength of the pulsed laser beam 31 differs from the wavelength of the guide laser beam 41. The second mirror 153 serving as the focusing optical system may be of a reflective type. In that case, chromatic aberration may not occur even when the wavelengths of the reflected laser beams differ from each other.

### 6.3 Effect

The optical sensor 110 may detect and/or measure properties of the guide laser beam 44 split by the beam splitter 100. The focus condition information of the detected guide laser beam 44 may include information on the focus condition of the pulsed laser beam 33. Accordingly, as the optical sensor 110 detects and/or measure properties of the guide laser beam 44, the focus position and the beam profile of the pulsed laser beam 33 may be detected or estimated. As a result, the optical sensor 110 may be able to monitor, in real-time, the position at which the pulsed laser beam 33 is focused and the beam profile (focus condition) of the focused pulsed laser beam 33.

Further, the guide laser beam 44 may be outputted even during the rest period TR of the burst operation. Accordingly, using the guide laser beam 44 to monitor and control the focus condition of the pulsed laser beam 33 may allow the focus position of the pulsed laser beam 33 to be detected even during the rest period TR. As a result, the focus condition of the lead pulse in a burst period B immediately following a rest period TR may be controlled to a desired condition.

### 7. EUV Light Generation System of Fourth Embodiment

A fourth embodiment of this disclosure will be described in detail with reference to the drawings.

### 7.1 Configuration

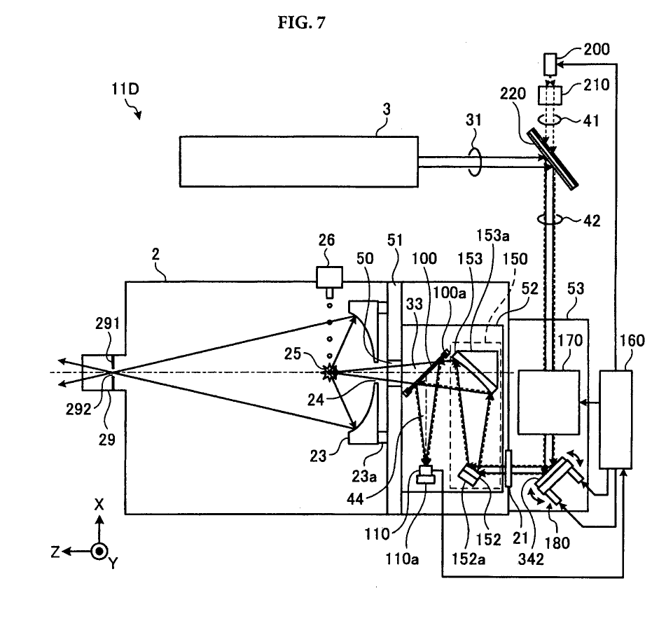

FIG. 7 schematically illustrates the configuration of an EUV light generation system 11D according to the fourth embodiment. As illustrated in FIG. 7, the EUV light generation system 11D may include a guide laser, a focusing optical system for the pulsed laser beam, a beam splitter, and a system for using feedback-control to adjust the focus position of the pulsed laser beam. Here, the EUV light generation system 11D may be similar in configuration to the EUV light generation system 11C shown in FIG. 6 and may further include the focus control unit 160, the focus position adjusting unit 170, and the mount 180 equipped with a tilt mechanism included in the EUV light generation system 11B shown in FIG. 5, and a plate 53. The focus position adjusting unit 170 may be disposed on the beam path between the beam path adjusting unit 220 and the high-reflection mirror 342. The high-reflection mirror 342 may be held by the mount 180. The focus position adjusting unit 170 and the mount 180 may be attached to the plate 53. The focus control unit 160 may be connected to the optical sensor 110. The focus control unit 160 may also be connected to the focus position adjusting unit 170 and the mount 180.

### 7.2 Operation

The guide laser beam 44 split by the beam splitter 100 may be focused on the photosensitive surface of the optical sensor 110. The focus condition information of the guide laser beam 44 detected and/or measured by the optical sensor 110 may be inputted to the focus control unit 160. Based on the inputted focus condition information, the focus control unit 160 may obtain or estimate the focus position and the beam profile of the pulsed laser beam 33 from the focus position and the beam profile of the guide laser beam 44. Then, based on the obtained or estimated focus position and beam profile, the focus control unit 160 may use feedback-control to control the focus position adjusting unit 170 and adjust the mount 180. With this, the focus condition of the pulsed laser beam 33 may be adjusted to a desired condition. The focus position adjusting unit 170 may adjust the wavefront of the laser beam incident thereon, to thereby adjust the focus position of the incident laser beam in the direction of the beam axis and the beam profile. The focus position adjusting unit 170 may further be used to adjust at least one of a beam axis (including a position of a beam axis and/or a direction of the beam axis) and divergence of the laser beam. The mount 180 may function as a beam axis adjusting unit. In that case, the mount 180 may adjust the orientation of the high-reflection mirror 342 to as to adjust the direction of the beam axis of the pulsed laser beam 31, to thereby adjust the focus position of the pulsed laser beam 33.

### 7.3 Effect

The focus condition of the guide laser beam 44 detected or measured by the optical sensor 110 may substantially reflect the focus condition of the pulsed laser beam 33. Accordingly, the focus control unit 160 may be able to use feedback-control to adjust the focus condition of the pulsed laser beam 33 in real-time. That is, the focus control unit 160 may use feedback-control based on the focus condition of the guide laser beam 44 detected or measured by the optical sensor 110 to adjust the focus condition of the pulsed laser beam 33. For example, the focus control unit 160 may use feedback-control to adjust the focus position of the pulsed laser beam 33 to a desired position. Further, the focus control unit 160 may control the focus position of the pulsed laser beam 33 so as to move the focus position to a desired position.

Further, the guide laser beam 44 may be outputted even during the rest period TR of the burst operation. Accordingly, using the guide laser beam 44 may allow the focus position of the pulsed laser beam 33 to be detected even during the rest period TR. As a result, the focus condition of the lead pulse in a burst period B immediately following a rest period TR may be controlled to a desired condition.

### 8. Beam Splitters

Variations of the beam splitter 100 will be described in detail with reference to the drawings.

### 8.1 Diamond Beam Splitter

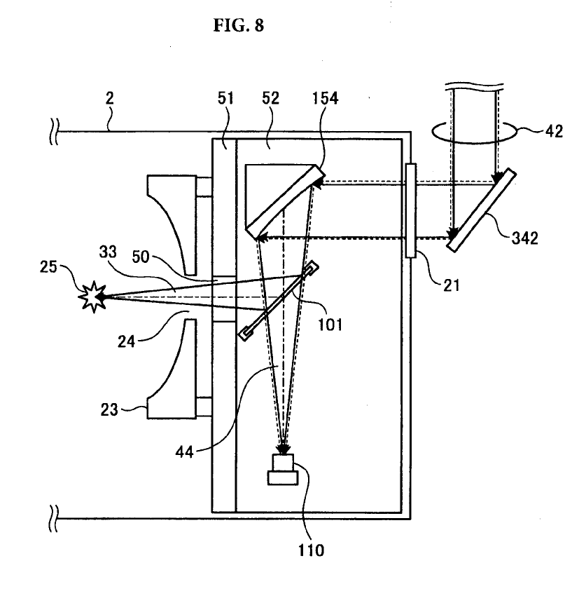

FIG. 8 schematically illustrates the configuration of a laser beam focusing optical system in which a diamond beam splitter is used. In the configuration shown in FIG. 8, a third mirror 154 including an off-axis paraboloidal mirror is provided in place of the first and second mirrors 152 and 153, and the laser beam 42 reflected by the high-reflection mirror 342 may be directly incident on the third mirror 154. A beam splitter 101, corresponding to the beam splitter 100, may be a diamond beam splitter formed of a diamond substrate. The laser beam 42 may include the guide laser beam, and the beam splitter 101 may be coated with an optical thin film on a surface facing the EUV collector mirror 23. The optical thin film may be configured to reflect the pulsed laser beam 33 component of the laser beam 42 with high reflectivity and transmit the guide laser beam component of the laser beam 42 with high transmissivity. The beam splitter 101 may be coated with an optical thin film, on a surface facing the optical sensor 110, for transmitting the guide laser beam component of the laser beam 42 with high transmissivity. Using the beam splitter 101 formed of a diamond substrate may make it possible to suppress thermal deformation in the beam splitter 101.

### 8.2 Mirror Having Through-Hole

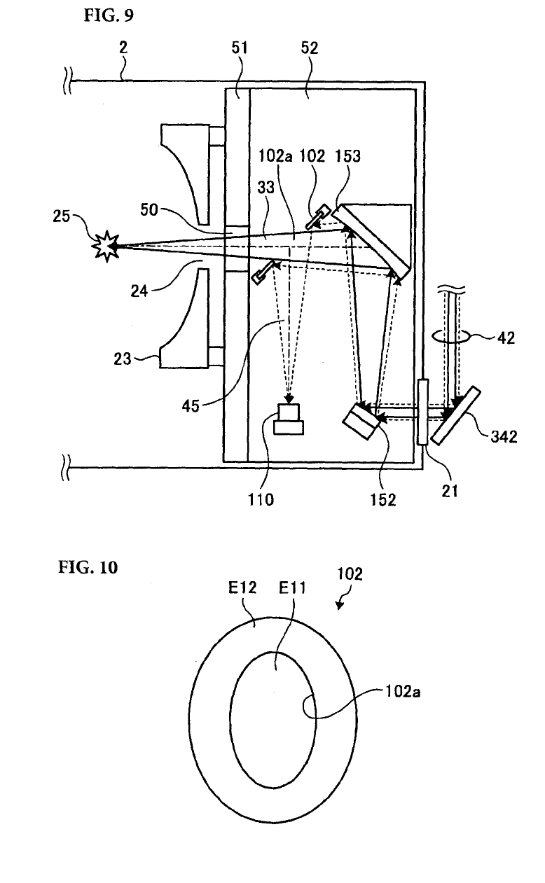

As illustrated in FIGS. 9 and 10, in place of the beam splitter 100, a beam splitter 102 having a through-hole 102a formed at the center thereof may be used. In this case, the guide laser beam 41 may be expanded in diameter by the beam expander 210 such that the cross-section of the guide laser beam 41 is larger than the cross-section of the pulsed laser beam 31. FIG. 9 schematically illustrates the configuration of a laser beam focusing optical system, in which a mirror having a through-hole according to another modification of the beam splitter is used, and FIG. 10 illustrates the shape of the mirror serving as the beam splitter shown in FIG. 9.

Here, the beam splitter 102 may be disposed such that the pulsed laser beam 33 included in the laser beam 42 passes through the through-hole 102a formed in a region Ell of the beam splitter 102. Parts of the guide laser beam that are outside of the pulsed laser beam may be reflected by a peripheral region E12 of the beam splitter 102. A guide laser beam 45 split from the laser beam 42 by the beam splitter 102 may be annular in cross-section and be focused on the photosensitive surface of the optical sensor 110. Meanwhile, the guide laser beam that has passed through the through-hole 102a may be focused in the plasma generation region 25.

The beam splitter 102 may have the through-hole 102a formed therein. In general, the beam splitter 102 may be circular (or annular, and having circular inner and outer edges), and the through-hole 102 formed therein may also be circular. In some embodiments, however, the beam splitter 102 and through-hole may have oval shapes. Since the pulsed laser beam passes through the through-hole 102a, the pulsed laser beam is not reflected by the beam splitter 102. Accordingly, the beam splitter 102 may not be heated by the pulsed laser beam; thus, thermal deformation in the beam splitter 102 may be suppressed and the guide laser beam may be detected with high precision. Additionally, the pulsed laser beam is not reflected by the beam splitter 102, and is incident on the plasma generation region 25.

### 8.3 Diffraction Grating

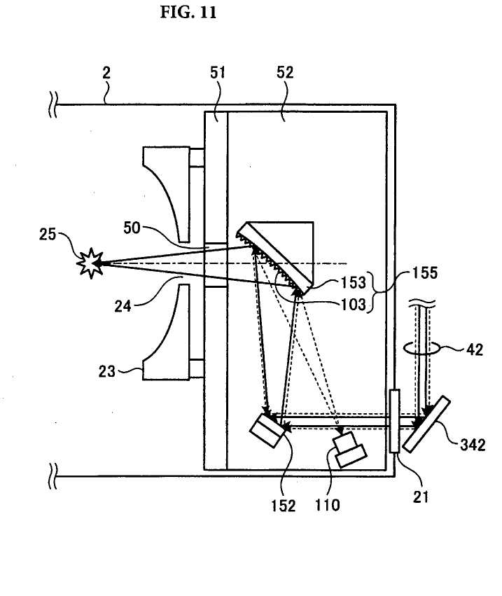

FIG. 11 schematically illustrates the configuration of a laser beam focusing optical system, in which a diffraction grating according to yet another modification of the beam splitter is used. As illustrated in FIG. 11, in place of the beam splitter 100, a beam splitter 103 having a diffraction grating may be used. Here, the beam splitter 103 may be mounted to the reflective surface of the second mirror 153. That is, a diffraction grating spheroidal concave focusing mirror 155 may include the beam splitter 103 and the second mirror 153.

A gap between two adjacent slits on the diffraction grating of the beam splitter 103 may be smaller than the wavelength of the pulsed laser beam and larger than the wavelength of the guide laser beam.

When the beam splitter 103 is used, the pulsed laser beam may be reflected at the reflective surface of the second mirror 153 with high reflectivity and be focused in the plasma generation region 25 without being diffracted by the beam splitter 103. Meanwhile, the guide laser beam may be diffracted by the beam splitter 103 and be focused on the photosensitive surface of the optical sensor 110. Accordingly, the optical sensor 110 may be disposed at a position at which the diffracted guide laser beam is focused. The diffraction grating spheroidal concave focusing mirror 155 may be equipped with both a focusing function and a beam splitting function; thus, the number of optical elements can be reduced and the laser beam focusing optical system may be made smaller in size.

### 9. EUV Light Generation System of Fifth Embodiment

A fifth embodiment of this disclosure will be described in detail with reference to the drawings.

### 9.1 Configuration

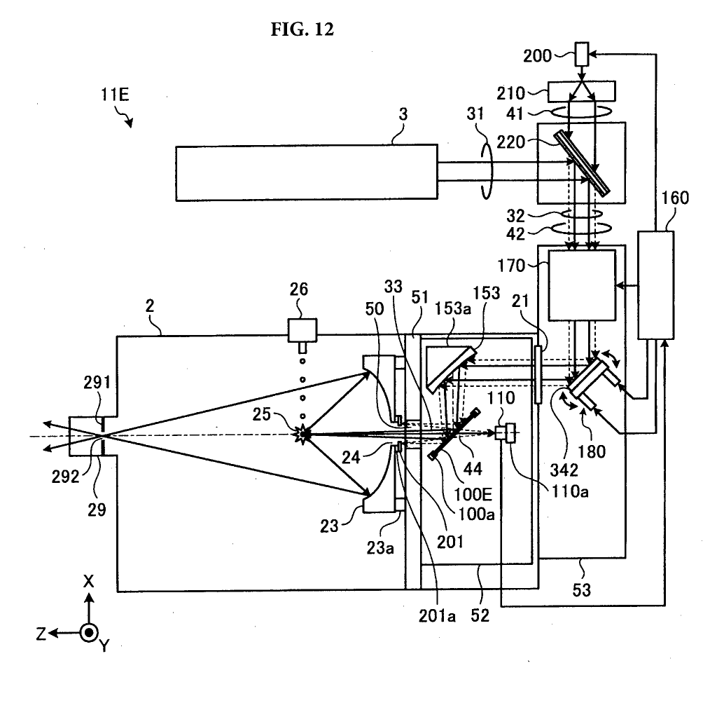

FIG. 12 schematically illustrates the configuration of an EUV light generation system 11E according to the fifth embodiment. As illustrated in FIG. 12, the EUV light generation system 11E may include a guide laser, a focusing optical system for the pulsed laser beam, a beam splitter, and a system for using feedback-control to adjust the focus position of the pulsed laser beam. The EUV light generation system 11E shown in FIG. 12 may include a guide laser beam mirror 201 in addition to the configuration of the EUV light generation system 11D shown in FIG. 7. Further, in the configuration shown in FIG. 12, the beam splitter 100 shown in FIG. 7 may be replaced by a high-reflection mirror 100E. Furthermore, in the configuration shown in FIG. 12, the optical sensor 110 may be disposed so as to be located opposite from and facing the guide laser beam mirror 201, with the high-reflection mirror 100E located between the optical sensor 110 and guide laser beam mirror 201.

The high-reflection mirror 100E may reflect the pulsed laser beam 33 with high reflectivity. The high-reflection mirror 100E may reflect part of the guide laser beam 44 and transmit another part thereof. The guide laser beam 44 transmitted through the high-reflection mirror 100E may be a so-called leak beam of the guide laser beam 44.

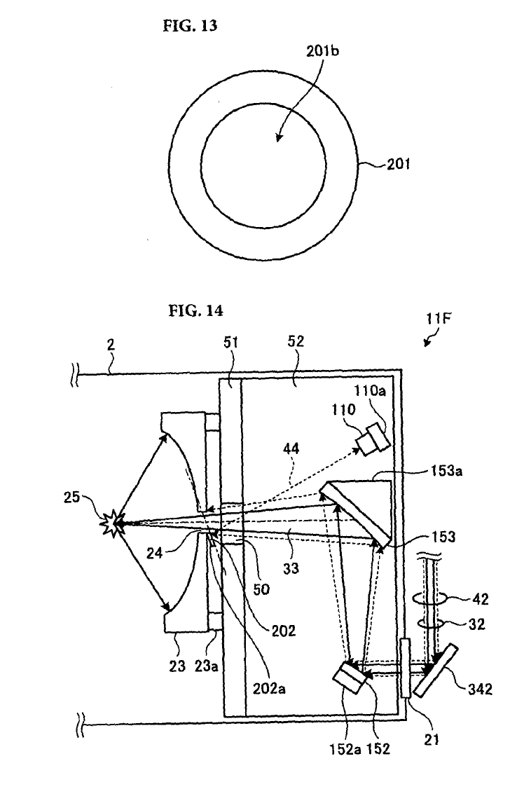

As illustrated in FIG. 13, the guide laser beam mirror 201 may have a through-hole 201b formed at the center thereof. In one example, the guide laser beam mirror 201 is circular (or annular, with circular inner and outer edges) and the through-hole 201b is circular. However, without being limited thereto, a mirror (for example, a dichroic mirror) that transmits the pulsed laser beam 33 and reflects the guide laser beam 44 may be used. The guide laser beam mirror 201 may be attached to the back surface of the EUV collector mirror 23, so as to surround the through-hole 24, via a holder 201a. Here, the through-hole 201b may overlap with the through-hole 24, when viewed from the side of the high-reflection mirror 100E.

The optical sensor 110 may preferably be disposed so as to be distanced by a predetermined distance from the guide laser beam mirror 201. Here, the predetermined distance is preferably equal to the distance between the first focus of the EUV collector mirror 23 and the reflective surface of the guide laser beam mirror 201. Further, the optical sensor 110 may preferably be disposed on an extension of an axis connecting the first focus of the EUV collector mirror 23 and the center of the guide laser beam mirror 201.

In the configuration shown in FIG. 12, the optical system for expanding the laser beam 42 in diameter (the first mirror 152 and the holder 152a shown in FIG. 7) may be omitted, and the laser apparatus 3 may be configured to output the pulsed laser beam 31 which is expanded in diameter. However, in other embodiments in which the laser apparatus 3 may not output a pulsed laser beam 31 having an expanded diameter, the optical system for expanding the laser beam 42 in diameter may be included as part of the optical system 11E and disposed upstream from the second mirror 153. As shown, the beam expander 210 disposed downstream from the guide laser 200 may preferably expand the guide laser beam 41 in diameter such that the cross-section of the guide laser beam 41 is larger than the cross-section of the pulsed laser beam 31.

### 9.2 Operation

In some embodiments, it may be preferable that the cross-section of the guide laser beam 41, which has been expanded in diameter by the beam expander 210, be larger than the cross-section of the pulsed laser beam 31. The beam axis of the guide laser beam 41 may be made to coincide with the beam axis of the pulsed laser beam 32 as the guide laser beam passes through the beam path adjusting unit 220.

The pulsed laser beam 33 reflected by the second mirror 153 may be reflected by the high-reflection mirror 100E. The pulsed laser beam 33 reflected by the high-reflection mirror 100E may travel through the through-hole 201b formed in the guide laser beam mirror 201 and the through-hole 24 formed in the EUV collector mirror 23 and be focused in the plasma generation region 25. Meanwhile, the guide laser beam 44 reflected by the second mirror 153 may be reflected by the high-reflection mirror 100E. At least an edge portion of the guide laser beam 44 reflected by the high-reflection mirror 100E may be reflected by the guide laser beam mirror 201, which is annular in shape. The edge portion of the guide laser beam 44 reflected by the guide laser beam mirror 201 may be incident on the high-reflection mirror 100E. The high-reflection mirror 100E may reflect part of the guide laser beam 44, but may transmit part of the guide laser beam 44 toward the optical sensor 110 disposed behind the high-reflection mirror 100E. Here, a returning beam of the guide laser beam 44 reflected by the guide laser beam mirror 201 may possibly be generated, but the intensity of this returning beam is weak and may generally not cause a problem.

The guide laser beam 44 reflected by the guide laser beam mirror 201 and transmitted through the high-reflection mirror 100E may be focused on the photosensitive surface of the optical sensor 110. The focus condition information of the guide laser beam 44 detected by the optical sensor 110 may be inputted to the focus control unit 160. Based on the inputted focus condition information, the focus control unit 160 may obtain the focus position and the beam profile of the guide laser beam 44, and may use the obtained focus position and beam profile of the guide laser beam 44 to estimate the focus position and the beam profile of the pulsed laser beam 33. Then, based on the obtained or estimated focus position and beam profile, the focus control unit 160 may use feedback-control to adjust the focus position adjusting unit 170 and control the orientation of the mount 180. With this, the focus condition of the pulsed laser beam 33 may be adjusted to a desired condition. The focus position adjusting unit 170 may adjust the wavefront of the laser beam incident thereon, to thereby adjust the focus position of the pulsed laser beam 33 in the direction of the beam axis and the beam profile. The focus position adjusting unit 170 may further be used to adjust at least one of a beam axis (including a position of a beam axis and/or a direction of the beam axis) and divergence of the laser beam. The mount 180 may function as a beam axis adjusting unit. In that case, the orientation of the mount 180 may be adjusted to control the direction of the beam axis of the pulsed laser beam 33, to thereby adjust the focus position.

### 9.3 Effect

The focus condition of the guide laser beam 44 detected by the optical sensor 110 may substantially reflect (or be indicative of) the focus condition of the pulsed laser beam 33. Accordingly, the focus control unit 160 may be able to use feedback-control to adjust the focus condition of the pulsed laser beam 33 in real-time. That is, the focus control unit 160 may use feedback-control based on the obtained focus condition of the guide laser beam 44 to adjust the focus condition of the pulsed laser beam 33. For example, the focus control unit 160 may use feedback-control to adjust the focus position of the pulsed laser beam 33 to a desired position. Further, the focus control unit 160 may control the focus position of the pulsed laser beam 33 so as to move to a desired position.

Further, the guide laser beam 44 may be outputted even during the rest period TR of the burst operation. Accordingly, using the guide laser beam 44 may allow the focus position of the pulsed laser beam 33 to be detected or estimated even during the rest period TR. As a result, the focus condition of the lead pulse in a burst period B immediately following a rest period TR may be controlled to a desired condition.

Further, the guide laser beam mirror 201 may be attached to the EUV collector mirror 23 via the holder 201a. In that case, a change in the direction and the relative position of the pulsed laser beam 33 (and the guide laser beam 44) with respect to the EUV collector mirror 23 may cause a change in the focus position of the edge portion of the guide laser beam 44 reflected by the guide laser beam mirror 201. The change in focus position of the edge portion of the guide laser beam 44 may be detected by the optical sensor 110. Accordingly, based on this detection result, the direction of the laser beam 42 may be controlled. With this, the focus position of the pulsed laser beam 33 may be controlled to the first focus of the EUV collector mirror 23 (and/or to the plasma generation region 25) with high precision. In this way, even when the first focus of the EUV collector mirror 23 is positioned outside of the predetermined plasma generation region 25 due to the EUV collector mirror 23 being moved, for example, the plasma generation region 25 may be re-set to the moved first focus of the EUV collector mirror 25.

### 10. EUV Light Generation System of Sixth Embodiment

A sixth embodiment of this disclosure will be described in detail with reference to the drawings. In FIG. 14, however, the elements similar to those shown in FIG. 7 are omitted.

### 10.1 Configuration

FIG. 14 schematically illustrates the configuration of an EUV light generation system 11F according to the sixth embodiment. As illustrated in FIG. 14, the EUV light generation system 11F may include a guide laser, a focusing optical system for the pulsed laser beam, a beam splitter, and a system for using feedback-control to adjust the focus position of the pulsed laser beam. Here, the EUV light generation system 11F shown in FIG. 14 may include a guide laser beam mirror 202 in addition to the configuration of the EUV light generation system 11D shown in FIG. 7. Further, in the configuration shown in FIG. 14, the beam splitter 100 and the holder 100a shown in FIG. 7 may be omitted.

The guide laser beam mirror 202 may be attached to the back surface of the EUV collector mirror 23, so as to surround at least part of the through-hole 24, via a holder 202a. The guide laser beam mirror 202 may be sectoral in shape following along the edge (or a portion of the edge) of the through-hole 24. In one example, the guide laser beam mirror 202 has the shape of a sector of an annulus, such as a sector of a guide laser beam mirror 201 shown in FIG. 13. The guide laser beam mirror 202 can be an annulus sector having an angle of, for example, 45°, 60°, 90°, 135°, 180°, 270°, or any other appropriate sector angle. However, the shape of the guide laser beam mirror 202 is not limited thereto.

The beam expander 210 disposed downstream from the guide laser 200 may preferably expand the guide laser beam 41 in diameter such that the cross-section of the guide laser beam 41 is larger than the cross-section of the pulsed laser beam 31. With this, part of the edge portion of the guide laser beam 44 reflected by the second mirror 153 may be incident on the guide laser beam mirror 202.

The optical sensor 110 may preferably be disposed such that the part of the guide laser beam 44 reflected by the guide laser beam mirror 202 is focused on the photosensitive surface of the optical sensor 110.

### 10.2 Operation

In some embodiments, it may be preferable that the cross-section of the guide laser beam 41, which has been expanded in diameter by the beam expander 210, be larger than the cross-section of the pulsed laser beam 31. The beam axis of the guide laser beam 41 may be made to coincide with the beam axis of the pulsed laser beam 32 as the guide laser beam 41 passes through the beam path adjusting unit 220.

The pulsed laser beam 33 reflected by the second mirror 153 may travel through the through-hole 24 formed in the EUV collector mirror 23 and be focused in the plasma generation region 25. Meanwhile, at least part of an edge portion of the guide laser beam 44 reflected by the second mirror 153 may be reflected by the guide laser beam mirror 202 disposed to surround at least part of the through-hole 24.

The part of the edge portion of the guide laser beam 44 reflected by the guide laser beam mirror 202 may be focused on the photosensitive surface of the optical sensor 110. The focus condition information of the guide laser beam 44 detected by the optical sensor 110 may be inputted to the focus control unit 160 (See FIG. 12). Based on the inputted focus condition information, the focus control unit 160 may obtain the focus position and the beam profile of the guide laser beam 44 and estimate the focus position and the beam profile of the pulsed laser beam 33. Then, based on the obtained or estimated focus position and beam profile, the focus control unit 160 may use feedback-control to control the focus position adjusting unit 170 and the mount 180 (See FIG. 12). With this, the focus condition of the pulsed laser beam 33 may be adjusted to a desired condition. The focus position adjusting unit 170 may adjust the wavefront of the laser beam incident thereon, to thereby adjust the focus position of the pulsed laser beam 33 in the direction of the beam axis and the beam profile. The focus position adjusting unit 170 may further be used to adjust at least one of a beam axis (including a position of a beam axis and/or a direction of the beam axis) and divergence of the laser beam. The mount 180 may function as a beam axis adjusting unit. In that case, the mount 180 may adjust the direction of the beam axis of the pulsed laser beam 33, to thereby adjust the focus position.

### 10.3 Effect

The focus condition of the guide laser beam 44 detected by the optical sensor 110 may substantially be indicative of the focus condition of the pulsed laser beam 33. Accordingly, the focus control unit 160 may use feedback-control to adjust the focus condition of the pulsed laser beam 33 in real-time. That is, the focus control unit 160 may use feedback-control to adjust the focus condition of the pulsed laser beam 33. For example, the focus control unit 160 may use feedback-control to adjust the focus position of the pulsed laser beam 33 to a desired position. Further, the focus control unit 160 may control the focus position of the pulsed laser beam 33 so as to move to a desired position.

Further, the guide laser beam 44 may be outputted even during the rest period TR of the burst operation. Accordingly, using the guide laser beam 44 may allow the focus position of the pulsed laser beam 33 to be detected or estimated even during the rest period TR. As a result, the focus condition of the lead pulse in a burst period B immediately following a rest period TR may be controlled to a desired condition.

Further, the guide laser beam mirror 202 may be attached to the EUV collector mirror 23 via the holder 202a. In that case, a change in the direction and the relative position of the pulsed laser beam 33 (and the guide laser beam 44) with respect to the EUV collector mirror 23 may cause a change in the focus position of the part of the edge portion of the guide laser beam 44 reflected by the guide laser beam mirror 202. The change in focus position of the part of the edge portion of the guide laser beam 44 may be detected by the optical sensor 110. Accordingly, based on this detection result, the direction of the laser beam 42 may be controlled. With this, the focus position of the pulsed laser beam 33 may be controlled to the first focus of the EUV collector mirror 23 (and/or to the plasma generation region 25) with high precision. In this way, even when the first focus of the EUV collector mirror 23 is positioned outside of the plasma generation region 25 due to the EUV collector mirror 23 being moved, for example, the plasma generation region 25 may be re-set to the moved first focus of the EUV collector mirror 25.

### 11. Supplementary Description

### 11.1 Mount Having Tilt Mechanism

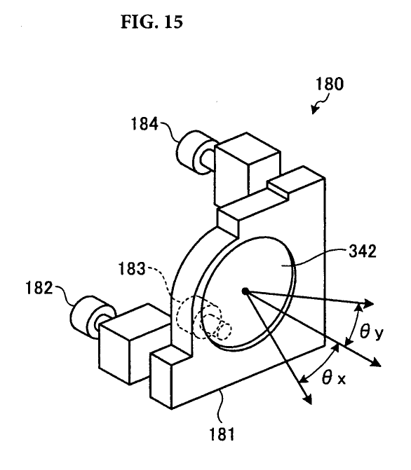

FIG. 15 is a perspective view illustrating an example of the mount 180 shown in FIGS. 5 and 7. As illustrated in FIG. 15, the mount 180 may include a holder 181, to which the flat high-reflection mirror 342 is attached, and three automatic micrometers 182 through 184, for example. Retaining the holder 181 adjustably with the automatic micrometers 182 through 184 may make it possible to adjust the angle θx in X-direction and the angle θy in Y-direction of the high-reflection mirror 342 attached to the holder 181.

### 11.2 Focus Position Adjusting Unit

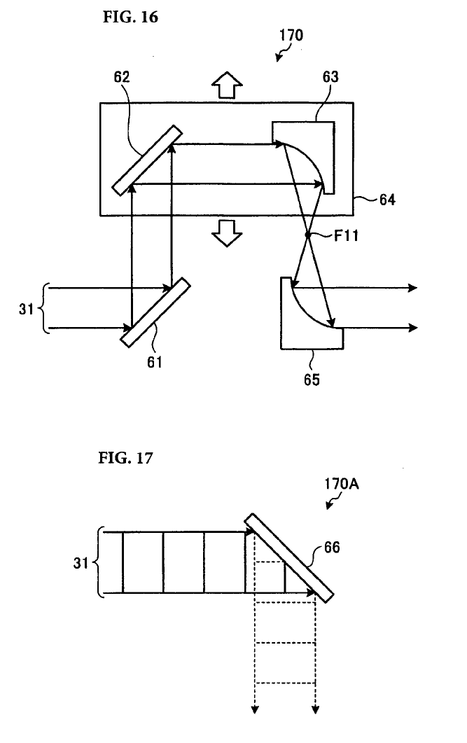

FIG. 16 illustrates an example of the focus position adjusting unit 170 shown in FIGS. 5 and 7. As illustrated in FIG. 16, the focus position adjusting unit 170 may include high-reflection mirrors 61 and 62 and off-axis paraboloidal concave mirrors 63 and 65. The high-reflection mirror 62 and the off-axis paraboloidal concave mirror 63 may be attached to a stage 64, which is movable with respect to the high-reflection mirror 61 and the off-axis paraboloidal concave mirror 65, for example. Moving the stage 64 to adjust the distance between the off-axis paraboloidal concave mirrors 63 and 65 may make it possible to adjust the wavefront of the pulsed laser beam 31 incident on the focus position adjusting unit 170 to a predetermined wavefront.

### 11.3 Modification of Focus Position Adjusting Unit

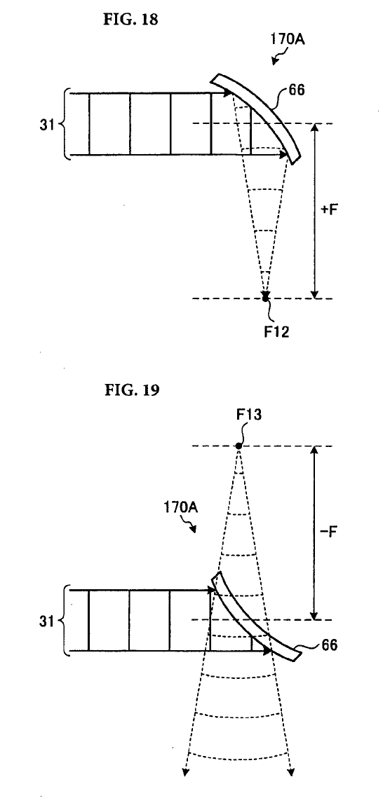

Further, the focus position adjusting unit 170 may be modified as shown in FIGS. 17 through 19. FIGS. 17 through 19 illustrate an example of a focus position adjusting unit 170A according to a modification. As illustrated in FIGS. 17 through 19, the focus position adjusting unit 170A may include a deformable mirror 66 having a reflective surface with a curvature that may be modified. The deformable mirror 66 may reflect the collimated pulsed laser beam 31 incident thereon as a collimated laser beam, when the reflective surface thereof is adjusted to be flat, as illustrated in FIG. 17. The deformable mirror 66, when the curvature of the reflective surface thereof is adjusted to be concave, may reflect the collimated pulsed laser beam 31 incident thereon such that the pulsed laser beam 31 is focused at a predetermined focus F12 distanced therefrom by a focal distance +F, as illustrated in FIG. 18. Alternatively, the deformable mirror 66, when the curvature of the reflective surface thereof is adjusted to be convex, may reflect the collimated pulsed laser beam 31 incident thereon as a convex beam such that the pulsed laser beam 31 may be focused at a virtual focus F13 distanced therefrom by a focal distance −F, as illustrated in FIG. 19. As has been described so far, using the deformable mirror 66 having a reflective surface with a curvature that may be modified, may make it possible to adjust the wavefront of the reflected laser beam to a predetermined wavefront in accordance with the wavefront of the laser beam incident thereon.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. An optical system used with a laser apparatus, the optical system comprising:
a focusing optical system having at least one focus, for focusing a laser beam outputted from the laser apparatus;
a beam splitter disposed between the focusing optical system and the at least one focus of the focusing optical system; and
an optical sensor disposed on a beam path of a laser beam split by the beam splitter.

2. The optical system according to claim 1, further comprising:
a focus position adjusting unit, disposed on a beam path of the laser beam upstream from the focusing optical system, for adjusting at least one of a beam axis and divergence of the laser beam; and
a focus control unit for controlling the focus position adjusting unit based on a detection result by the optical sensor.

3. The optical system according to claim 2, wherein
the optical sensor detects a focus condition of the laser beam, and
the focus control unit controls the focus position adjusting unit based on the focus condition detected by the optical sensor.

4. The optical system according to claim 3, wherein the focus condition includes at least one of a focus position of the laser beam, divergence of the laser beam, a position of a beam axis of the laser beam, and a direction of the beam axis of the laser beam.

5. The optical system according to claim 1, further comprising a beam path adjusting unit for making a beam path of a first laser beam outputted from a first laser apparatus and a beam path of a second laser beam outputted from a second laser apparatus coincide with each other.

6. The optical system according to claim 5, wherein
the laser beam includes the first and second laser beams,
the beam splitter transmits the first laser beam and reflects the second laser beam, and
the optical sensor is disposed on the beam path of the second laser beam reflected by the beam splitter.

7. The optical system according to claim 1, wherein the focusing optical system is a reflective type optical system.

8. The optical system according to claim 1, wherein the beam splitter includes a diamond substrate.

9. An optical system used with first and second laser apparatuses, the optical system comprising:
a beam path adjusting unit for making a beam path of a first laser beam outputted from the first laser apparatus and a beam path of a second laser beam outputted from the second laser apparatus coincide with each other;
a focusing optical system having at least one focus, for focusing the first laser beam outputted from the first laser apparatus and the second laser beam outputted from the second laser apparatus;
an optical sensor for detecting a focus position of the second laser beam;
a focus position adjusting unit disposed on a beam path of the first and second laser beams upstream from the focusing optical system, for adjusting at least one of a beam axis and divergence of the first and second laser beams; and
a focus control unit for controlling the focus position adjusting unit based on a detection result by the optical sensor.

10. An extreme ultraviolet light generation system used with a laser apparatus, the extreme ultraviolet light generation system comprising:
a chamber provided with at least one inlet through which a laser beam outputted from the laser apparatus is introduced into the chamber;
a target supply unit for supplying a target material to a predetermined region inside the chamber;
a focusing optical system for focusing at least part of the laser beam in the predetermined region;
a beam splitter disposed between the focusing optical system and the predetermined region;
an optical sensor disposed on beam path of a laser beam split by the beam splitter; and
a collector mirror for collecting extreme ultraviolet light emitted as the target material is irradiated by the laser beam inside the chamber.

11. The extreme ultraviolet light generation system according to claim 10, further comprising a beam path adjusting unit for making a beam path of a first laser beam outputted from a first laser apparatus and a beam path of a second laser beam outputted from a second laser apparatus coincide with each other.

12. The extreme ultraviolet light generation system according to claim 11, wherein
the laser beam includes the first and second laser beams,
the beam splitter transmits the first laser beam and reflects the second laser beam, and
the optical sensor is disposed on the beam path of the second laser beam reflected by the beam splitter.

13. An extreme ultraviolet light generation system used with first and second laser apparatuses, the extreme ultraviolet light generation system comprising:
a beam path adjusting unit for making a beam path of a first laser beam outputted from the first laser apparatus and a beam path of a second laser beam outputted from the second laser apparatus coincide with each other;
a chamber provided with at least one inlet through which the first laser beam outputted from the first laser apparatus and the second laser beam outputted from the second laser apparatus are introduced into the chamber;
a target supply unit for supplying a target material to a predetermined region inside the chamber;
a focusing optical system for focusing the first and second laser beams in the predetermined region;
an optical sensor for detecting a focus position of the second laser beam;
a focus position adjusting unit, disposed on the beam path of the first and second laser beams upstream from the focusing optical system, for adjusting at least one of a beam axis and divergence of the first and second laser beams;
a focus control unit for controlling the focus position adjusting unit based on a detection result by the optical sensor; and
a collector mirror for collecting extreme ultraviolet light emitted as the target material is irradiated by the laser beam inside the chamber.
